(19) United States
(12) Patent Application Publication
(10) Pub. No.: US 2005/0251801 A1
(43) Pub. Date: Nov. 10, 2005

(54) Tuning control method and system using thereof

(75) Inventors: Hideki Takano, Yokohama (JP); Shigeru Miyake, Tokyo (JP); Takeshi Ishizaki, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/051,082

(22) Filed: Feb. 4, 2005

(30) Foreign Application Priority Data
Feb. 6, 2004 (JP) 2004-030038

(51) Int. Cl. G06F 7/00

(52) U.S. Cl. 717/174

(57) ABSTRACT

In a multilayered system having a hierarchical structure and comprising a plurality of programs, optimal operation parameters for each program are computed. A parameter setting unit 104 sets a parameter 111 for an operation of each program 112. A program start/stop unit 105 starts and stops operation of each program 112. A performance information measurement unit 106 measures performance information of the multilayered system 110. An experiment control unit 102 activates the unit 104, the unit 105, and the unit 106, and executes experiments for operating the multilayered system 110. A next parameter set decision unit. 103 decides a combination of parameters used in a next experiment based on a result of measurement of the performance information. The tuning control unit 101 controls the unit 102 and the unit 103 to repeat the experiment until a condition for termination of the experiment is satisfied.

### CLAIM OF PRIORITY

The present application claims priority from Japanese Application P2004-030038 filed on Feb. 6, 2004, the content of which is hereby incorporated by reference into this application.

### FIELD OF THE INVENTION

The present invention relates to a tuning system for optimizing operation parameters of a multilayered system having a hierarchical structure and comprising a plurality of programs.

### BACKGROUND OF THE INVENTION

With repeated mergers of business enterprises and development of diversified business activities, a corporate information system supporting various activities of each business enterprise has been becoming increasingly complicated. In the business environment as described above, in order to realize high performance with low cost, now it is required to provide performance tuning so that a plurality of programs operating in correlation to each other can efficiently operate without losing good coordination and balance between the programs.

An experienced specialist having enough knowledge concerning operations of programs and hardware can carry out tuning by building up various types of information measurable when a system is run and rules for parameters to be set when the measured information shows a specific feature as a fuzzy inference base. For instance Japanese Patent Laid-Open No. 11-249934 discloses the performance tuning system as described above.

However, there are few experts well familiar with the complicated system as a whole. Even if such expert is available, it is extremely difficult to define all of the rules required for tuning.

It is difficult to find out optimal operation parameters for each of programs forming a multilayered system.

### SUMMARY OF THE INVENTION

The present invention provides a control technology for tuning a performance of a multilayered system having a hierarchical structure and comprising a plurality of programs, and this control technology is realized by executing a computer program and is characterized in that operation parameters for each of the programs each constituting the multilayered system are set; each program is actuated; performance information for the multilayered system is measured; after operation of each program is stopped, a set of next parameters as a combination of parameters used when running the multilayered system next is decided with reference to a result of measurement of performance information so that the performance information is optimized; and the steps described above are sequentially repeated until a prespecified condition for terminating the operation sequence is satisfied.

With the present invention, anybody can easily decide an optimal parameter set even for a multilayered system comprising a plurality of programs, for which the optical operation parameters are hardly decided with the conventional technology.

### BRIEF DESCRIPTION OF THE DRAWINGS

FIG. 1 is a block diagram showing a tuning system according to one embodiment of the present invention;

FIG. 2 is a view showing hardware configuration of a computer;

FIG. 3 is a view showing a tuning sequence;

FIG. 4 is a system block diagram showing a case when tuning of a Web system is carried out;

FIG. 5 is a view showing an example of a set file used by a tuning control program;

FIG. 6 is a PAD showing a processing sequence executed by the tuning control program in Embodiment 1;

FIG. 7 is a view showing a sequence of processing executed by an experiment control unit in Embodiment 1;

FIG. 8 is a PAD showing a sequence of processing for deciding a set of next parameters in Embodiment 1;

FIG. 9 is a PAD showing a sequence of processing for computing a reflecting position;

FIG. 10 is a PAD showing a sequence of processing for computing a retracting position;

FIG. 11 is a view showing an example of a set file for a tuning control program used in Embodiment 2;

FIG. 12 is a PAD showing a sequence of processing executed by the tuning control program in Embodiment 2;

FIG. 13 is a view showing an example of a set file for a tuning control program in Embodiment 3;

FIG. 14 is a PAD showing a sequence of processing executed by the tuning control program in Embodiment 3;

FIG. 15 is a view showing a sequence of processing executed by an experiment control unit in Embodiment 4;

FIG. 16 is a view showing an example of a set file for a tuning control program in Embodiment 5; and

FIG. 17 is a PAD showing a sequence of processing for deciding a set of next parameters in Embodiment 6.

### DETAILED DESCRIPTION OF THE PREFERRED EMBODIMENTS

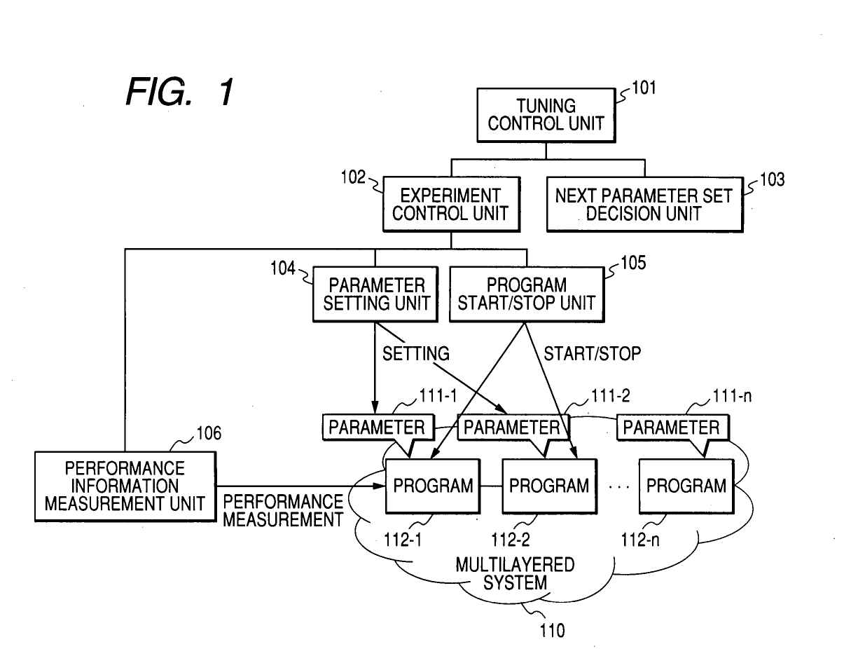

FIG. 1 is a block diagram showing a tuning system according to an embodiment of the present invention. A multilayered system 110 is a system to be tuned, and programs 112-1, 112-2, . . . 112-n each as a system component operate in the multilayered system 110. Each of the programs 112-1, 112-2, . . . 112-n has parameters 111-1 to 111-n each as an operation parameter for setting operations of the program.

The tuning control system used for tuning the parameters comprises programs for a tuning control unit 101, an experiment control unit 102, a next parameter set decision unit 103, a parameter setting unit 104, a program start/stop unit 105, and a performance information measurement unit 106. The parameter setting unit 104 sets values for the parameters 111-1 to 111-n. The program start/stop unit 105 is a program for starting and stopping the programs 112-1 to 112-n for the multilayered system 110. The performance information measurement unit 106 actuates the multilayered system 110, for instance, by sending a request, and measures the performance information. The experiment control unit 102 makes the parameter setting unit 104, program start/stop unit 105, and performance information measurement unit 106 run for carrying out an experiment. The next parameter set decision unit 103 is a program for deciding parameters to be tested next by using an optimization algorithm and based on the performance information measured as described above. The tuning control unit 101 is a program for executing an experiment by controlling the experiment control unit 102 and next parameter set decision unit 103. In the following description, the term “program 1120 may sometimes be used to indicate any of the programs 112-1 to 112-n. The same is true also for other system components.

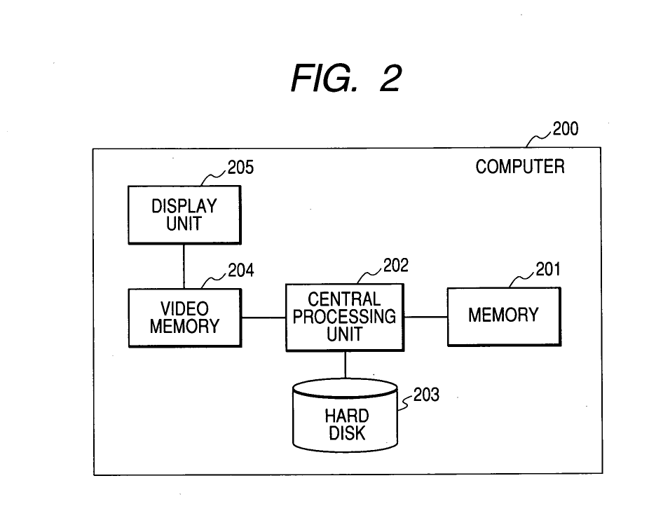

The programs 112-1 to 112-n and system components 101 to 106 in the tuning control system are programs which can run in a computer, and may be provided in one or more computers. FIG. 2 is a view showing hardware configuration of a computer 200 used according to the present embodiments. A hard disk 203 stores therein various types of data such as the programs or parameters. A central processing unit 202 reads the various types of data stored in the hard disk 203 into a memory 201 when necessary. Also when a program is to be run, the program is at first read into the memory 201 and then executed by the central processing unit 202. A video memory 204 is a memory for storing therein data used for display, and data change in the video memory 204 is reflected to the display unit 205.

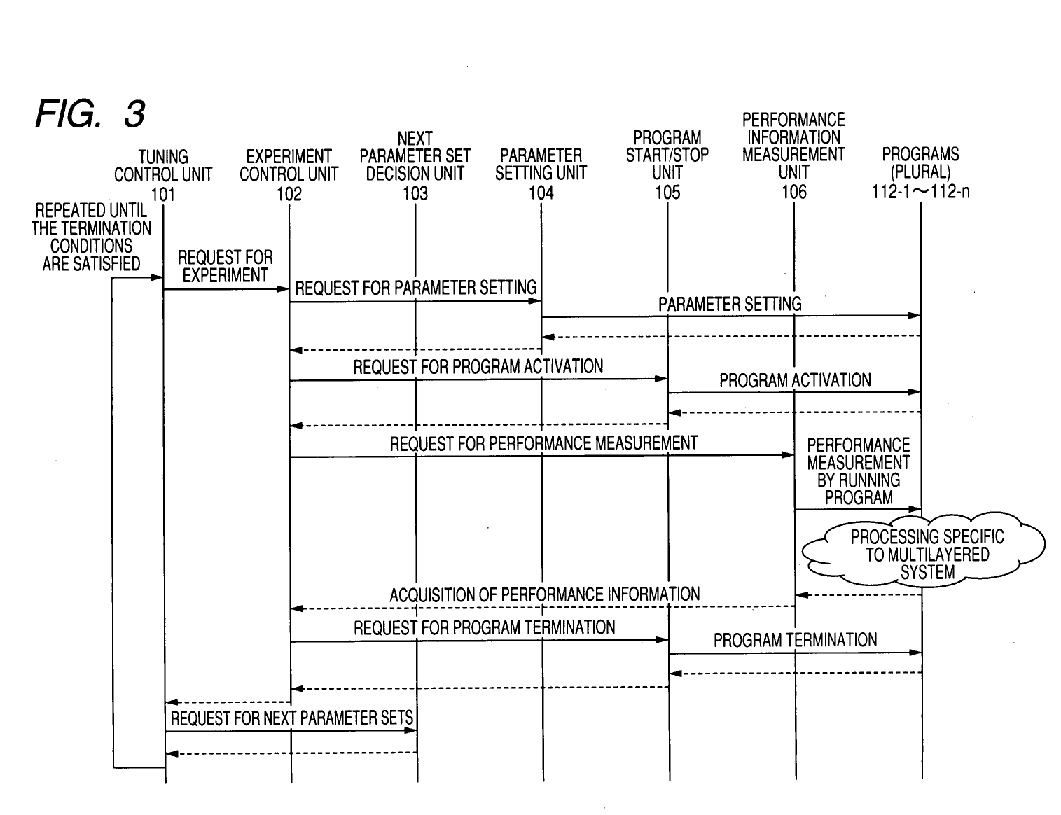

FIG. 3 is a sequence diagram showing the tuning system. The tuning control unit 101 issues a demand for an experiment to the experiment control unit 102. The experiment control unit 102 issues a request for setting parameters to the parameter setting unit 104. The parameter setting unit 104 sets parameters, for instance, in set files under control by the programs 112-1 to 112-n for the system components. Then the experiment control unit 102 issues a request for activation of the program to the program start/stop unit 105 to activate the programs 112-1 to 112-n for the system components. Then the experiment control unit 102 issues a demand for measurement of performance information to the performance information measurement unit 106. The performance information measurement unit 106 measures the performance information for the multilayered system 110 by running the programs 112-1 to 112-n. The multilayered system 110 herein executes actual processing by activating one or more computers for executing the programs 112-1 to 112-n. The experiment control unit 102 fetches the measured performance information. Then the experiment control unit 102 issues a demand for terminating execution of the programs to the program start/stop unit 105, and the program start/stop unit 105 terminates execution of the programs for the system components. The tuning control unit 101 demands next parameters to the next parameter set decision unit 103. The next parameter set decision unit 103 computes a set of parameters to be tested next using the performance information measured as described above, and returns the set of parameters to the tuning control unit 101. The tuning control unit 101 repeats the processing sequence starting from the issuance of a demand for an experiment using the parameters. The tuning control unit 101 computes a set of parameters providing the optimal performance measurement values by repeating the experiments until conditions for termination of the experiment are satisfied.

### (1) Embodiment 1

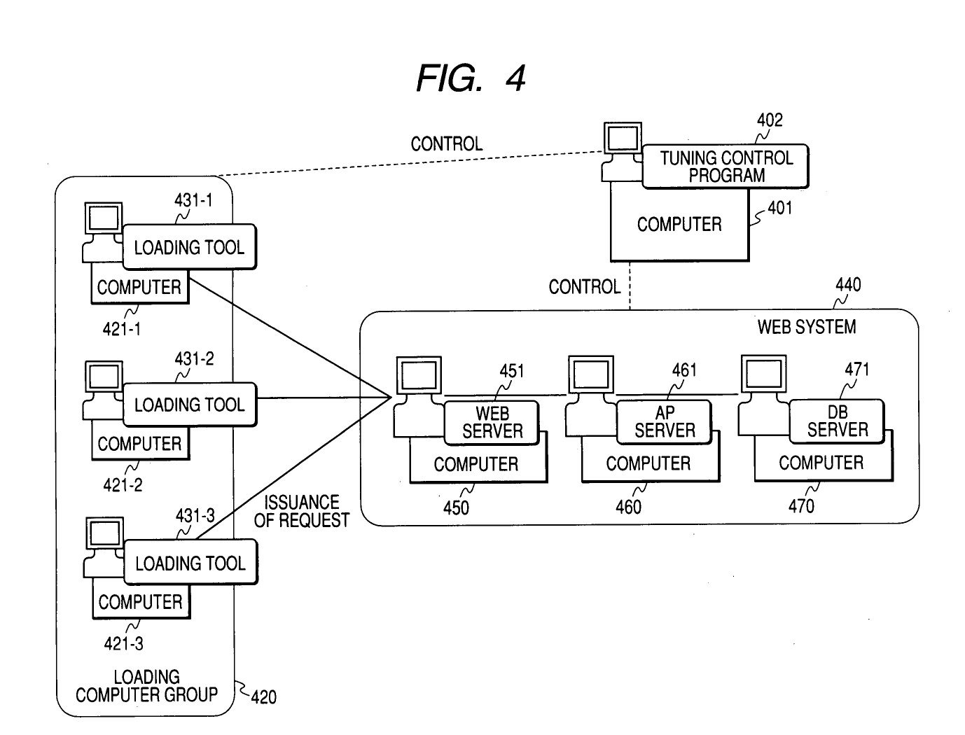

FIG. 4 is a block diagram showing a system for tuning performance of a Web system. The system comprises a Web system 440, a computer 401 for running a tuning control program 402, and a group of loading computer group 420. The Web system 440 comprises computers 450, 460, and 470 which are connected to each other through a network. A Web server 451 runs on the computer 450, an AP (application) server 461 runs on the computer 460, and a DB (database) server 471 runs on the computer 470. In this example, the Web system 440 corresponds to the multilayered system 110 comprising three layers, and the Web server 451 corresponds to the program 112-1, the AP server 461 to the program 112-2 and the DB server 471 to the program 112-3, respectively. The Web system 440 in which these programs run in correlation to each other is a target for tuning. The loading computing group 420 comprises computers 421-1 to 421-3. The computers 421-1 to 421-3 make each of the loading tools 431-1 to 431-3 run. Each of the loading tool 431-1 to 431-3 simultaneously issues a number of requests to the Web server 451 in the Web system 440 to place a load to each program in the Web system 440, and measures the performance information from a situation until a response is received. Namely each of the loading tools 431-1 to 431-3 includes the performance information measurement unit 106. The tuning control program 402 controls the loading computer group 420 and the Web system 440. The tuning control program 402 comprises the tuning control unit 101, experiment control unit 102, next parameter set decision unit 103, parameter setting unit 104, and program start/stop unit 105.

In Embodiment 1, there are three parameters to be tuned, namely a maximum number of processing simultaneously executable in the Web server 451, a maximum number of processing simultaneously executable in the AP server 461, and a maximum number of pools which the AP server can maintain connection with the DB server 471. The maximum number of processing simultaneously executable indicates a number of processes, threads, or tasks simultaneously executed by the program in response to the issuance of requests. The tuning control program 402 computes a combination of parameters (parameter set) optimizing the performance of the Web system 440. In this example, the downhill simplex method is used as an algorithm for optimization.

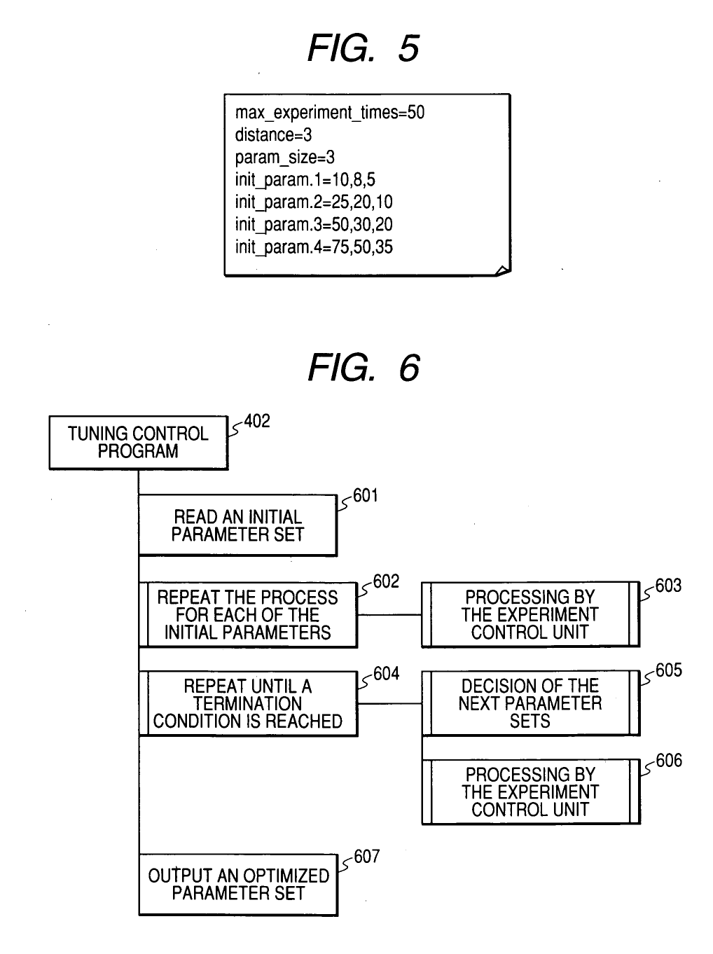

FIG. 5 is a view showing an example of data in a set file in which operations of the tuning control program 402 are set. Maximum experiment times (max_experiment_times) indicate a maximum number of experiments executable until termination of one experiment. The parameter set can be expressed with dots on a three-dimensional parameter space in this example. The distance (distance) sets distances between the parameter set at the best point and each of other three parameters when optimized. When all of the three distances are within values preset with distance, it is determined that the performance information has been converged to the optimal values. The initial parameter set (init_param.1-4) are those given when an experiment is started, and a number of the initial parameter sets is a number of parameters actually required +1. Values in a parameter set are those for the three parameters sequentially set. The set file is stored in a storage device of the computer 401.

FIG. 6 is a PAD (problem analysis diagram) showing a sequence of processing executed by the tuning control program 402. The tuning control unit 101 in the tuning control program 402 at first reads in the initial parameter set from the set file (step 601). Then the tuning control unit 101 repeats the processing in step 603 for all of the prepared initial parameter sets to acquire the performance information (step 602). In this example, there are four initial parameter sets, so that the processing in step 603 is repeated four times. The performance information implies here a throughput or an average response time. The throughput indicates a number of requests executable within a unit period of time. The average response time is an average time for a period of time required from a point of time when the loading tool 431 issues a request until a response to the request is received. In step 603, the tuning control unit 101 calls the experiment control unit 102. The experiment control unit 102 activates the parameter setting unit 104, sets an initial parameter set in the Web system 440 to activate the Web system 440, and executes an experiment for acquiring the performance information.

Then the tuning control unit 101 provides controls so that the processing in step 605 and that in step 606 are repeatedly executed until the condition for termination of the experiment is satisfied (step 604). Herein the condition for termination of the experiment indicates that the distance condition described above is satisfied, or that the times of experiments reach the maximum experiment times. In step 605, the tuning control unit 101 activates the next parameter set decision unit 103. The next parameter set decision unit 103 decides one or more parameter sets for the next experiment with reference to a result of the previous experiment. The downhill simplex method is applied to decision of the next parameter sets. In step 606, the tuning control unit 101 calls the experiment control unit 102 like in step 603. The experiment control unit 102 activates the parameter setting unit 104, sets the decided next parameter sets in the Web system 440 to activate the Web system 440, and executes an experiment for acquiring the performance information. When the condition for termination of the experiment is satisfied, the tuning control unit 101 outputs a parameter set showing the best performance information among those measured up to the time point to a display unit 205 as an optimal parameter set (step 607).

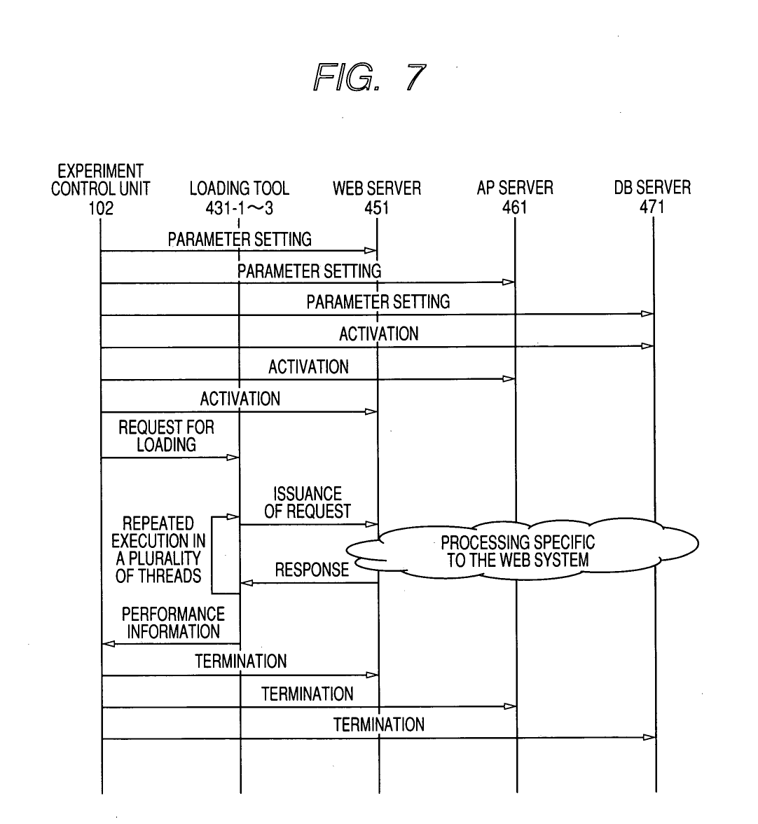

FIG. 7 is a view showing a sequence of processing executed in step 603 and step 606. The experiment control unit 102 sets parameters via the parameter setting unit 104 in each of the Web server 451, AP server 461, and DB server 471. Then the experiment control unit 102 sequentially activates the programs for the DB server 471, AP server 461, and Web server 451 via the program start/stop unit 105. Then the experiment control unit 102 demands loading to the loading tools 431-1 to 431-3. The loading tools 431-1 to 431-3 issue a request to the Web system 440 repeatedly. Each of the loading tools 431 issues a plurality of requests almost simultaneously using a plurality of threads. The performance information measurement unit 106 computes the performance information from a time point when a response is received, and reports the computed performance information to the experiment control unit 102. Then the experiment control unit 102 stops execution of the programs for the Web server 451, AP server 461, and DB server 471 via the program start/stop unit 105. As described below, when a plurality of next parameter sets are decided in step 605, the experiment is repeated for each of the parameter sets.

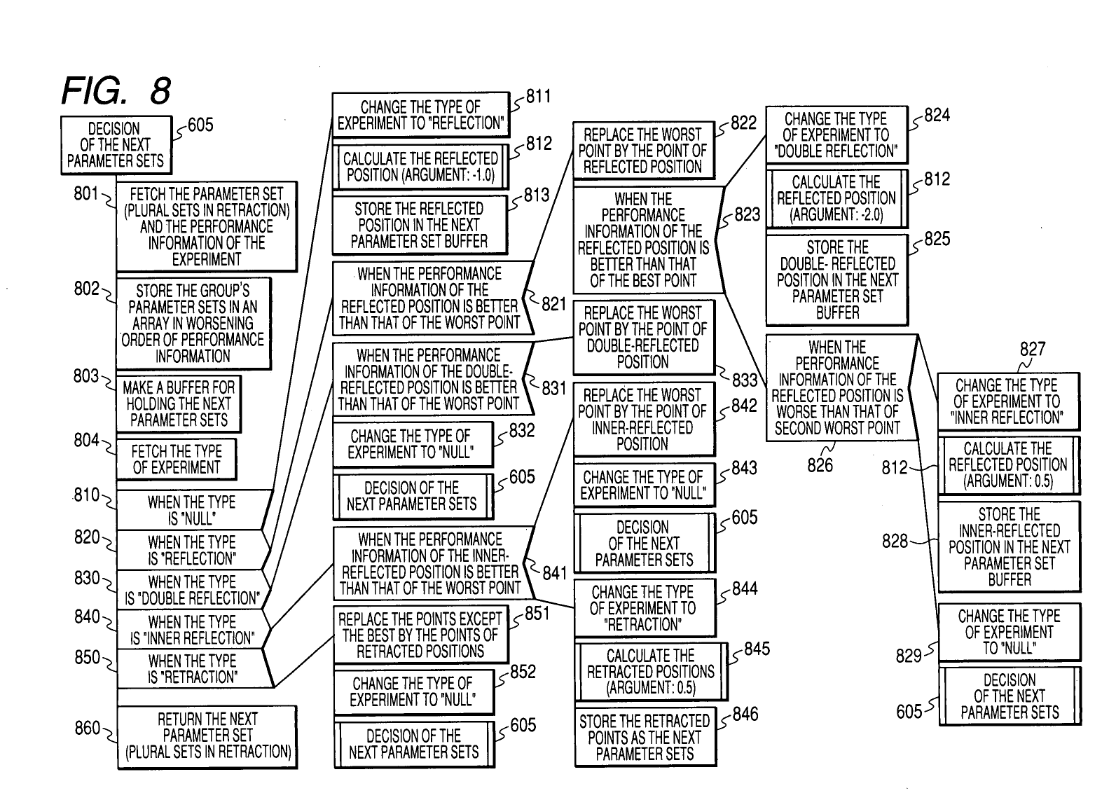

FIG. 8 is a PAD showing a sequence of processing for deciding a next parameter set in step S605. The next parameter set decision unit 103 fetches the parameter sets used in the experiment and the measured performance information (step 801). In the case of retraction as described above, the next parameter set decision unit 103 fetches a plurality of parameter sets and performance information corresponding to each of the parameter sets. Then the next parameter set decision unit 103 stores the parameter sets of the parameter set group in an array in the worsening order (step 802). Therefore the parameter set at the best point is placed at the head of the array. The better performance information, in the case of throughput, indicates a larger throughput. In the case of response time, the better performance information indicates a shorter response time. The parameter set group herein indicates parameter sets equivalent to a number of parameters +1 used in the downhill simplex method. In this example, the parameter set group consists of four parameter sets. When a parameter set group has been stored in the array, in this example, the best four performance information among the existing parameter sets belonging to the group and those fetched in step 801 are selected, and are re-stored in this array. Then a buffer for storing therein the next parameter sets is prepared (step 803). Then the next parameter set decision unit 103 fetches a type of the experiment and stored the type information in the buffer (step 804). For a type of experiment in the initial state, “null” is stored.

When a type of an experiment is “null” (step 810), the next parameter set decision unit 103 changes the experiment type to “reflection” (step 811), and computes a reflection point for the current target point in the parameter space according to the procedure described below (step 812). The argument in this step is −1.0. Then the next parameter set decision unit 103 stores the reflection point in a buffer-for the next parameter set (step 813). Then the next parameter set decision unit 103 returns the next parameter set to the tuning control unit 101 (step 860).

When the experiment type is “reflection” (step 820) and the performance information at the reflection point is better than that at the worst point (step 821, YES), the next parameter set decision unit 103 replaces the worst point with the reflection point (step 823). When the performance information at the reflection point is better than that at the best point (step 823, YES), the next parameter set decision unit 103 changes the experiment type to “double reflection” (step 824). Then the next parameter set decision unit 103 obtains a position for double reflection of the worst point among the four points on the parameter space according to the procedure described later (step 812). The argument in this step is −2.0. Then the next parameter set decision unit 103 stores the position for double reflection in the buffer for the next parameter set (step 825).

When the performance information at the reflection position is worse than that at the best point (step 823, NO) and the performance information at the reflection position is worse than that at the second worst position (step 826, YES), the next parameter set decision unit 103 changes the experiment type to “inner reflection” (step 827). Then the next parameter set decision unit 103 computes a position for inner reflection for the worst point among the four points on the parameter space according to the procedure described later (step 812). The argument in this step is 0.5. Then the next parameter set decision unit 103 stores the position for inner reflection in the buffer for the next parameter set (step 828). When the performance information at the reflection position is the same as or better than that at the second worst point (step 826, NO), the next parameter set decision unit 103 changes the experiment type to “null”, and again executes the processing for deciding the next parameter sets (step 605).

When the experiment type is “double reflection” (step 830) and the performance information at the double reflection position is better than that at the worst point (step 831), the next parameter set decision unit 103 replaces the worst point with a point for the double reflection position (step 833). Then the next parameter set decision unit 103 changes the experiment type to “null”, and again executes the processing for deciding the next parameter set (step 605).

When the experiment type is “inner reflection” (step 840) and the performance information at the inner reflection position is better than that at the worst point (step 841, YES), the next parameter set decision unit 103 replaces the worst point with a point for the inner reflection position (step 842). Then the next parameter set decision unit 103 changes the experiment type to “null” (step 843), and again executes the processing for deciding the next parameter sets (step 605). When the performance information at the inner reflection position is worse than that at the worst point (step 841, NO), the next parameter set decision unit 103 changes the experiment type to “retraction” (step 844). Then the next parameter set decision unit 103 computes a position for retraction from four points on the parameter space according to the procedure described below (step 845). The argument in this step is 0.5. Then the next parameter set decision unit 103 stores the positions for the retraction points in the buffer for the next parameter sets (step 846).

When the experiment type is “retraction” (step 850), the next parameter set decision unit 103 replaces the points other than the best point with the points for the retraction positions (step 851). Then the next parameter set decision unit 103 changes the experiment type to “null” (step 852), and again executes decision of the next parameter sets (step 605).

When arriving at the final step 860 in each processing sequence, the next parameter set decision unit 103 returns the next parameter sets to the tuning control unit 101.

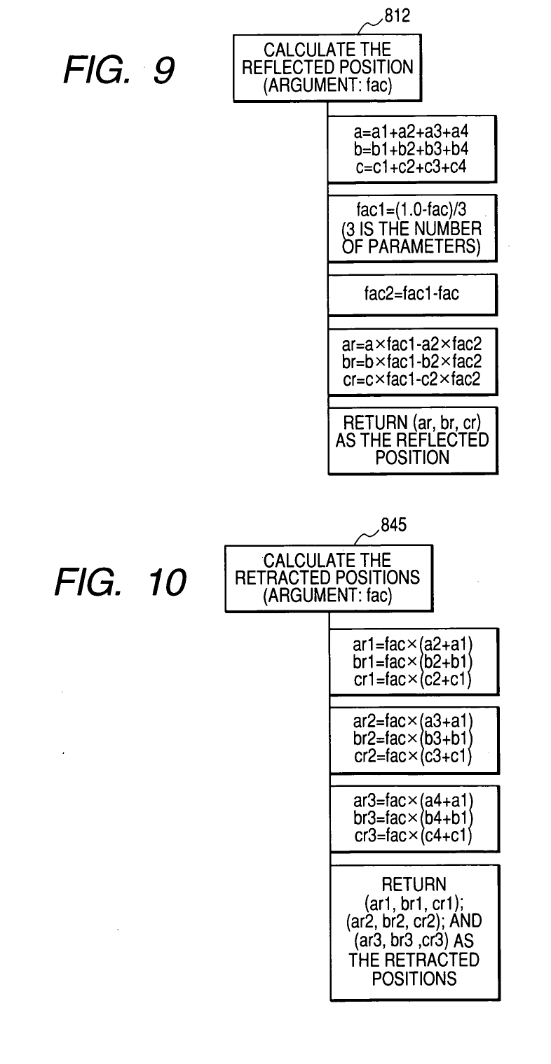

FIG. 9 is a PAD showing a processing sequence for computing a reflection position in step 812. For convenience of description, a case is described in which the parameter set groups are (a1, b1, c1), (a2, b2, c2), (a3, b3, c3) and (a4, b4, c4), and the worst point is (a2, b2, c2). The argument is assumed to be fac. This argument indicates a distance for reflection, and a value of the argument is −1.0 for the “reflection” position, −2.0 for the “double reflection” position, and 0.5 for the “inner reflection” position. The computing is executed according to the following sequence.
A=a1+a2+a3+a4 (Equation 1)
B=b1+b2+b3+b4 (Equation 2)
C=c1+c2+c3+c4 (Equation 3)
fac1=(1.0−fac)/3 (3: Number of parameters) (Equation 4)
fac2=fac1−fac (Equation 5)
ar=a×ac1−a2×fac2 (Equation 6)
br=b×fac1−b2×fac2 (Equation 7)
cr=c×fac1−c2×fac2 (Equation 8)
(ar, br, cr) indicates a reflection point.

FIG. 10 is a PAD showing the processing sequence for computing a position for retraction in step 845. For convenience of description, a case is described in which the parameter set groups are (a1, b1, c1), (a2, b2, c2), (a3, b3, c3) and (a4, b4, c4) and the best point is (a1, b1, c1). The argument is fac. In a case of retraction, fac is 0.5.
ar1=fac×(a2+a1) (Equation 9)
br1=fac×(b2+b1) (Equation 10)
cr1=fac×(c2+c1) (Equation 11)
ar2=fac×(a3+a1) (Equation 12)
br2=fac×(b3+b1) (Equation 13)
cr2=fac×(c3+c1) (Equation 14)
ar3=fac×(a4+a1) (Equation 15)
br3=fac×(b4+b1) (Equation 16)
cr3=fac×(c4+c1) (Equation 17)
(ar1, br1, cr1) (ar2, br2, cr2), and (ar3, br3, cr3) computed through the operational sequence above are positions for retraction.

### (2) Embodiment 2

In Embodiment 1, when the best point is found at the same point in a plurality of experiments, it is not clear whether the best point is a true best point or the best point is recognized accidentally as a result of each experiment. In Embodiment 2, the experiment is repeated again by using the parameter set at the best point, and an average of the measured performance information and the performance information at the previous best point is regarded as the true best point.

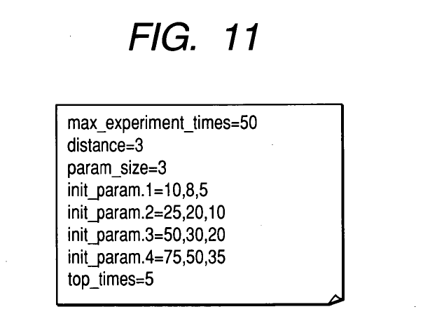

FIG. 11 is a view showing an example of data in a set file for setting operations of the tuning control program 402 in Embodiment 2. Different from the example of a set file in Embodiment 1, the set item of times (top times) when the same point is determined as the best point over a plurality of experiments is additionally provided.

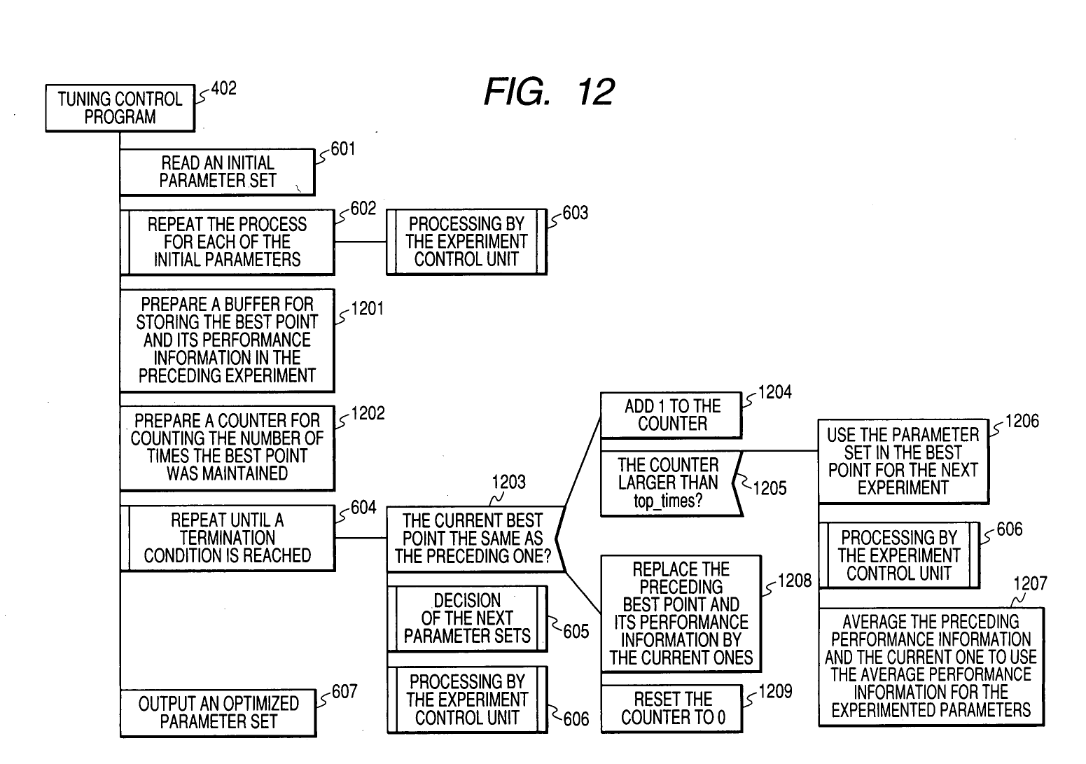

FIG. 12 is a PAD showing a sequence of processing executed by the tuning control program 402 in Embodiment 2. After the operations in step 601 to step 603 are finished, the tuning control unit 101 prepares a buffer for storing therein the parameter set at the best point in the previous experiment and the performance information also acquired in the previous experiment (step 1201). Then the tuning control unit 101 prepares a counter for counting times when the same point are recognized as the best point over a plurality of experiments in a row (step 1202). The initial value of the counter is 0 (zero). Then the tuning control unit 101 provides controls to repeatedly execute the operations in step 1203 to 1207 (including step 606) until the condition for termination of the experiment is satisfied (step 604).

When the best point is obtained in the preceding experiment and the same point is recognized as the best point also in the current experiment (step 1203, YES), the tuning control unit 101 increments the value stored in the counter by 1 (step 1204). When the counter value is larger than times (top_times) (step 1205), the parameter set at the best point is again employed as the next parameter set for the next experiment (step 1206). In step 606, the tuning control unit 101 activates the next parameter set decision unit 103 and again executes an experiment with the same parameter set. A result of the experiment does not always indicate the same performance information. Then the tuning control unit 101 calculates an average of the preceding performance information and the current performance information, and regards the average as the performance information of the parameter set used in the current experiment (step 1207). In a case where the best point was not obtained in the preceding experiment or the best point in the preceding experiment is different from that obtained in the current experiment (step 1203, NO), the tuning control unit 101 replaces the parameter sets at the preceding best point and the preceding performance information in the buffer with the parameter set at the current best point and the current performance information, respectively (step 1208). If the preceding best point is not available, the tuning control unit 101 simply stores the parameter set at the current best point and the performance information in the buffer. Then the tuning control unit 101 initializes the counter to 0 (zero) (step 1209).

Sometimes it is possible to escape from the temporal best point remaining there to the true best point by repeating the experiments in Embodiment 2.

### (3) Embodiment 3

In Embodiment 3, tuning is performed by executing the initial experiments more times than a number of parameters plus 1 to speed up the convergence to the optimal solution.

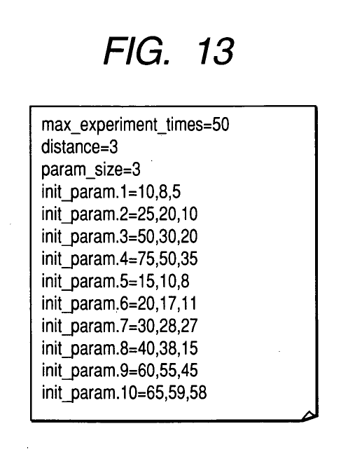

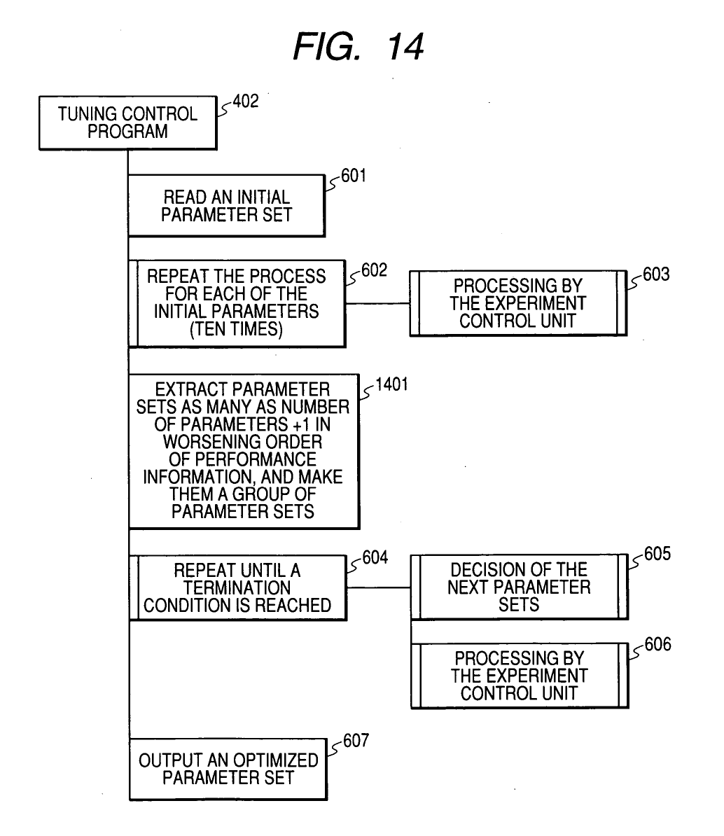

FIG. 13 is a view showing an example of data in a set file for setting therein operations of the tuning control program 402 in Embodiment 3. In this example, 10 parameter sets from init_param. 1 to init_param. 10 are set as initial parameter sets.

FIG. 14 is a PAD showing a sequence of processing executed by the tuning control program 402 in Embodiment 3. The tuning control unit 101 repeats the processing in step 603 to all of the initial parameter sets to acquire the performance information (step 602). In this example, there are 10 parameter sets, so that the processing in step 603 is repeated 10 times. Then the tuning control unit 101 extracts the parameter sets as many as a number of parameters plus 1 in the worsening order of the performance information, and regards these parameter sets as a parameter set group. The operations in step 604 to 607 are the same as those in Embodiment 1.

### (4) Embodiment 4

When a program 112 for the multilayered system 110 is executed under the program execution environment such as Java VM, sometimes the ad hoc processing such as that for removing the unnecessary portions (Garbage Collection (GC)) may be executed. In Embodiment 4, a result of performance measurement concerning a time zone spent for the ad hoc processing as described above is excluded from the target for sampling. (Note: Java is a registered trade mark owned by Sun Microsystems Inc.).

Description of the Embodiment 4 assumes a case in which, in the Web system 440 to be tuned, the AP server 461 utilizes Java VM and GC occurs at odd intervals. The Web system 440 comprises a program capable of monitoring occurrence of GC, monitors time points when GC from Java VM occurs and ends, and stores the information in a storage device.

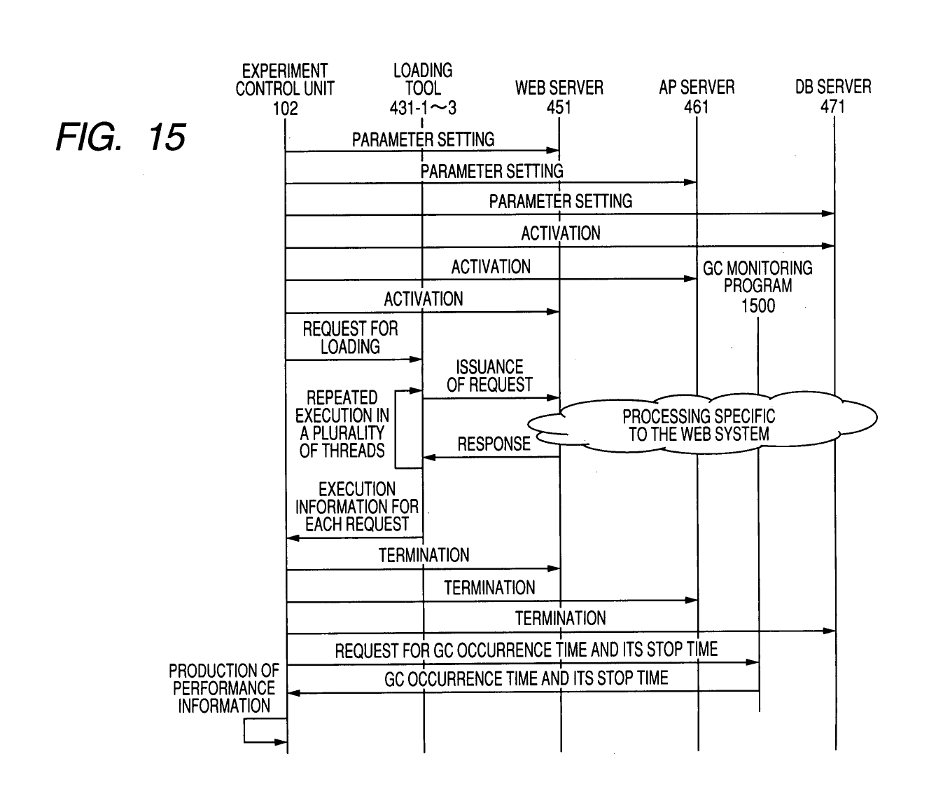

FIG. 15 is a view showing a sequence of processing in step 603 and in step 606. A GC monitoring program 1500 monitors the time points when GC occurs and ends, and stores the information. A loading tool 431 repeatedly sends requests and then returns the information concerning how each request is executed to the experiment control unit 102. This information for execution includes a time point when each request is sent and a time point when a response to the request is returned. Next the experiment control unit 102 generates performance information based only on the information concerning how each request is executed, information concerning occurrence of GC, and also information concerning how the request is executed in a time zone in which new GC does not occur after the end of previous GC.

### (5) Embodiment 5

Embodiment 5 is a case in which a value of a parameter derived by the next parameter set decision unit 103 is corrected to a specific multiple obtained by multiplying the parameter value, for instance, by 2 or 3. With this operation, a parameter set can be quickly converged to a solution near the optimal solution.

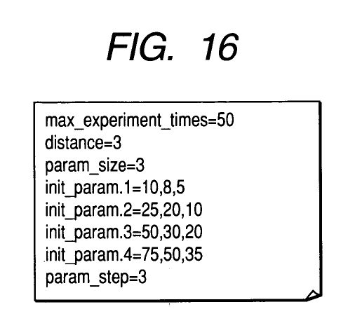

FIG. 16 is a view showing an example of data in a set file for setting therein operations of the tuning control program 402 in Embodiment 5. In this example, a step between values allowable for each parameter (param_step) is added to the example of data in Embodiment 1. In this example, the step is 3, so that each parameter value can only be a multiple of 3. In this example, however, the initial parameters are the same as those employed in Embodiment 1, and the parameter value is not limited to a multiple of 3.

Then the next parameter set decision unit 103 corrects the parameter values to multiples of a number specified with param_step before returning the next parameter set to the tuning control unit 101. When correcting each parameter value, for instance, each of the computed parameter values in the parameter set is divided by param_step and the quotient is subjected to half adjustment or rounding down below decimal point to obtain an integral number, and a next parameter value is obtained by multiplying the value by param_step. Alternatively, each computed parameter value in the parameter set is divided by param_step, and the obtained odd is subtracted from the original value.

### (6) Embodiment 6

Embodiment 6 is a case in which, when a parameter set derived by the next parameter set decision unit 103 is the same as that at the best point, values of the parameters in the parameter set are finely increased or decreased for a random correction. This correction is performed by adding 1 to or subtracting 1 from each of the original values. With this operation, fine search can be made around the best point.

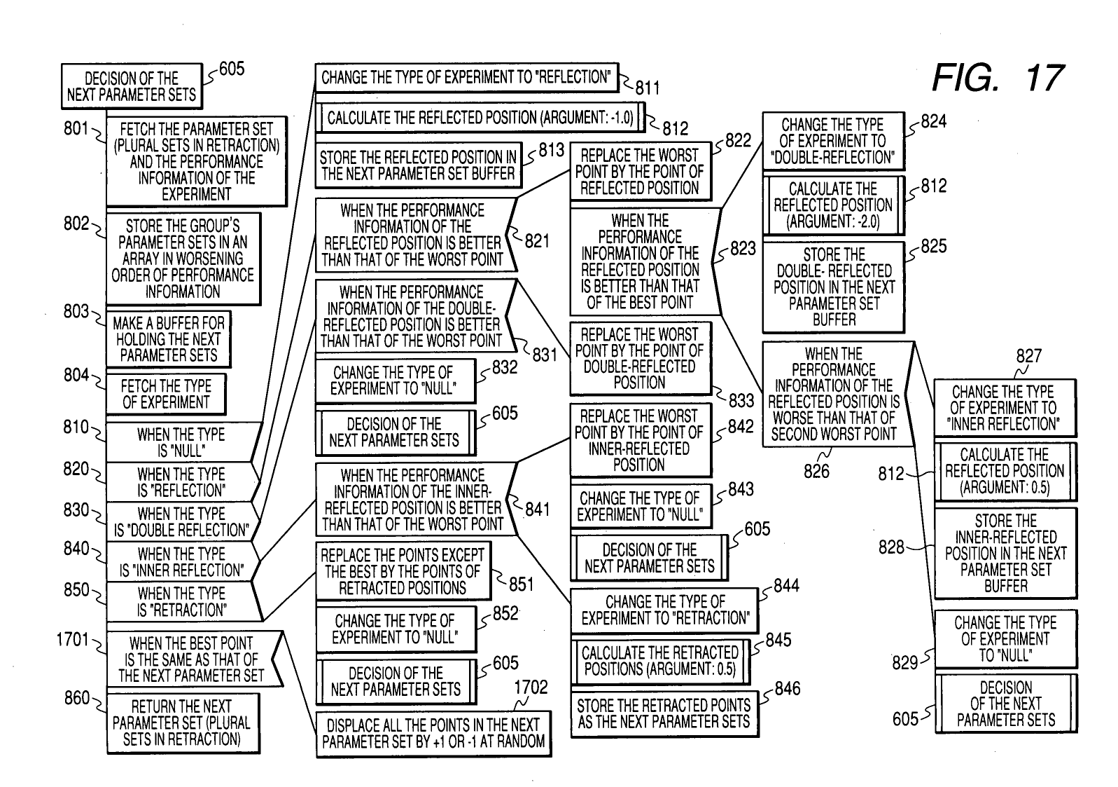

FIG. 17 is a PAD showing a sequence of processing (step 605) for deciding the next parameter sets in Embodiment 6. When the next parameter set is the same as that at the best point (step 1701), the next parameter set decision unit 103 executes at random add 1 to or subtract 1 from the parameter values at all points in the next parameter set before executing the processing in step 860 (step 1702).

With the embodiments described above, anybody can easily perform tuning, before starting use of a multilayered system, when the configuration is changed in association with replacement of any hardware, or when an application running in the system is exchanged with another. The present invention can also be applied to tuning of a Web system, which has been becoming increasingly important day by day. As parameters to be tuned, in addition to the maximum number of simultaneously executable operations executed in the Web server, AP server, and DB server, also a maximum number of queues maintained by each server can be tuned with this invention.

Having described a preferred embodiment of the present invention with reference to the accompanying drawings, it is to be understood that the invention is not limited to the embodiments and that various changes and modifications could be effected therein by those skilled in the art without departing from the spirit or scope of the present invention as defined in the appended claims.

1. A tuning control system for tuning performance of a multilayered system having a hierarchical structure and comprising a plurality of programs, said tuning control system comprising as program components executed by a computer:
a parameter setting unit for setting parameters for an operation of each of the programs constituting said multilayered system;
a program start/stop unit for starting and stopping an operation of each of said programs;
a performance information measurement unit for measuring performance information of said multilayered system;
an experiment control unit for conducting an experiment by activating said parameter setting unit, said program start/stop unit and said performance information measurement unit, operating said multilayered system;
a next parameter set decision unit for deciding a next parameter set(s) which is a combination of the parameters to be used in the next experiment based on a result of said measurement of performance information; and
a tuning control unit for controlling said experiment control unit and said next parameter set decision unit so that said experiment is repeated with said next parameter sets thus decided until a prespecified condition for termination of the experiment is satisfied;
wherein said next parameter set decision unit decides said parameter set so that said performance information is optimized.

2. The tuning control system according to claim 1, wherein said multilayered system is a Web system having each program for a Web server, an application server, and a database server.

3. The tuning control system according to claim 1 further comprising a loading tool as a program component, which includes said performance information measurement unit, for loading by simultaneously issuing a plurality of requests to said multilayered system.

4. The tuning control system according to claim 1,
wherein after said tuning control unit fetches the performance information corresponding to each initial parameter set by causing initial experiments to be executed using the initial parameter sets as many as a number of parameters plus one, said next parameter set decision unit makes the parameter set converge to one point on a parameter space so that said performance information is optimized by applying a downhill simplex method to the fetched performance information.

5. The tuning control system according to claim 1,
wherein, when the best parameter set is kept unchanged throughout prespecified times of experiments, said tuning control unit executes the experiment once again for said best parameter set, and delivers to said next parameter set decision unit an average of the measured performance information and the performance information corresponding to said best parameter set previously measured instead of the performance information for said best parameter set.

6. The tuning control system according to claim 4,
wherein after said tuning control unit causes said initial experiments to be executed using the initial parameter sets of a number more than the number of parameters plus one, said tuning control unit selects the initial parameter sets as many as a number of parameters plus one in the worsening order of the performance information to deliver the selected parameter sets to said next parameter set decision unit.

7. The tuning control system according to claim 1,
wherein said tuning control system further comprises a program for monitoring a time interval during which the ad hoc processing is executed during execution of the programs constituting said multilayered system, and said experiment control unit removes the performance information relating to said time zone time interval reported by the monitoring program from a target for performance measurement.

8. The turning control system according to claim 4,
wherein said next parameter set decision unit corrects said next parameter set so that each parameter of the next parameter set becomes multiplied by a pre-specified integral number.

9. The tuning control system according to claim 4,
wherein, when said next parameter set corrected by said next parameter set decision unit are equal to a next parameter set in best point respectively,
each parameter of said next parameter set corrected by said next parameter set decision unit is amended with a small value in comparison with said each parameter, increasingly or decreasingly at random.

10. A tuning control method for a performance of a multilayered system having a hierarchical structure and comprising a plurality of programs, said tuning control method realized by execution of a program by a computer comprising the steps of:
setting parameters for an operation of each of the programs constituting said multilayered system;
activating each of said programs;
measuring performance information for said multilayered system;
stopping execution of said each program; and
deciding a next parameter set(s) which is a combination of said parameters used for next operation of said multilayered system based on a result of measurement of said performance information;
wherein, in said step of deciding the next parameter set(s), said parameter set(s) is decided so that said performance information is optimized and the steps above are repeated successively until a prespecified condition for termination of the experiment is satisfied.

11. The tuning control method according to claim 10,
wherein said multilayered system is a Web system having each program for a Web server, an application server, and a database server.

12. The tuning control method according to claim 10,
wherein, after the programs constituting said multilayered system are activated, a plurality of requests are simultaneously issued to said multilayered system for applying a load thereto.

13. The tuning control method according to claim 10,
wherein, in said step of setting the parameters, the initial parameter sets as many as a number of parameters plus one are initially set, said performance information for said initial parameter sets is measured, and after said performance information for said initial parameter sets is acquired, in said step of deciding the next parameter set(s), said next parameter set(s) is decided by applying a downhill simplex method to the acquired performance information to make the parameter set converge to one point on a parameter space so that the performance information is optimized at the point.

14. The tuning control method according to claim 10,
wherein, when it is detected that the best parameter set is kept unchanged throughout the prespecified times of the multilayered system operations while the steps are sequentially executed, said multilayered system is operated once again for said best parameter set, and an average value of the measured performance information and the performance information corresponding to said best parameter set previously measured is recognized as said next parameter set instead of said best parameter set in said step of deciding the next parameter sets.

15. The tuning control method according to claim 13,
wherein, in said step of deciding the next parameter set(s), said initial parameter sets of a number more than the number of parameters plus one are initially set, said performance information is measured to acquire the performance information for said initial parameter sets, and then the initial parameter sets as many as a number of parameters plus one are selected in the worsening order of the performance information to execute the step of deciding said next parameter set.

16. The tuning control method according to claim 10,
wherein, in said step of measuring performance information, a time zone in which the ad hoc processing is executed during execution of the programs constituting said multilayered system is monitored, and the performance information relating to the time zone is removed from a target for performance measurement.

17. The tuning control method according to claim 13, wherein said next parameter set decision unit corrects said next parameter set so that each parameter of the next parameter set becomes multiplied by a pre-specified integral number.

18. The tuning control method according to claim 13,
wherein when said next parameter set corrected by said next parameter set decision unit are equal to a next parameter set in best point respectively
each parameter of said next parameter set corrected by said next parameter set decision unit is amended with a small value in comparison with said each parameter, increasingly or decreasingly at random.
